(19) United States
(12) Patent Application Publication
(10) Pub. No.: US 2026/0219529 A1
(43) Pub. Date: Jul. 30, 2026

(54) LIQUID CRYSTAL DEVICE AND ELECTRONIC APPARATUS

(71) Applicant: SEIKO EPSON CORPORATION, Tokyo (JP)

(72) Inventor: Hidekazu HIRABAYASHI, SHIOJIRI-SHI (JP)

(73) Assignee: SEIKO EPSON CORPORATION, Tokyo (JP)

(21) Appl. No.: 19/460,336

(22) Filed: Jan. 27, 2026

(30) Foreign Application Priority Data
Jan. 28, 2025 (JP) 2025-011991

(51) Int. Cl. G02F 1/1335; G02F 1/1343

(52) U.S. Cl. CPC G02F 1/133526; G02F 1/134309

(57) ABSTRACT

A liquid crystal device includes a first substrate, and a second substrate including a lens layer, wherein the first substrate includes a plurality of pixel apertures, each of the plurality of pixel apertures has a rectangular shape having a first longitudinal direction and a first transverse direction in plan view, the lens layer includes a plurality of first lenses and a plurality of second lenses, a convex surface of each of the plurality of second lenses includes a second planar portion disposed at a center and a second curved portion disposed so as to surround the second planar portion in plan view, the second planar portion has a rectangular shape having a second longitudinal direction and a second transverse direction in plan view, the second longitudinal direction is the same direction as the first longitudinal direction, and the second transverse direction is the same direction as the first transverse direction.

The present application is based on, and claims priority from JP Application Serial Number 2025-011991, filed January 28, 2025, the disclosure of which is hereby incorporated by reference herein in its entirety.

### BACKGROUND

### 1. Technical Field

The present disclosure relates to a liquid crystal device and an electronic apparatus.

### 2. Related Art

An electronic apparatus provided with a liquid crystal device including liquid crystal between two substrates is known. In such an electronic apparatus, it is required to realize high light use efficiency.

In JP-A-2015-069187 described below, a microlens array substrate includes a substrate provided with a plurality of concave portions so as to correspond to a plurality of pixels, and a lens layer disposed so as to fill the plurality of concave portions. Each of the plurality of concave portions includes a planar portion, a curved portion, and a rim portion.

JP-A-2015-069187 is an example of the related art.

However, in JP-A-2015-069187, when aperture shapes for sectioning the plurality of pixels are complicated due to wiring patterns and so on, there is a possibility that wiring lines and so on are irradiated with light. Therefore, there is a problem that light to be incident on the pixels is blocked, and thus, the light use efficiency is decreased.

### SUMMARY

In order to solve the problem described above, a liquid crystal device according to an aspect of the present disclosure includes: a first substrate having a light transmissive property and including a plurality of pixel electrodes; a second substrate disposed so as to face the first substrate and including a lens layer; and a liquid crystal layer disposed between the first substrate and the second substrate, wherein the first substrate includes a plurality of pixel apertures which is disposed so as to correspond respectively to the plurality of pixel electrodes, and on which light from the lens layer is incident, each of the plurality of pixel apertures has a rectangular shape having a longitudinal direction and a transverse direction in plan view, the second substrate has a first surface on which the light is incident and a second surface from which the light is emitted, the lens layer includes a plurality of first lenses and a plurality of second lenses disposed so as to correspond respectively to the plurality of pixel electrodes, the plurality of first lenses is disposed at the first surface side of the second substrate, the plurality of second lenses is disposed at the second surface side with respect to the plurality of first lenses, the plurality of first lenses and the plurality of second lenses are arranged such that convex surfaces of the plurality of first lenses and convex surfaces of the plurality of second lenses face to respective sides opposite to each other, at least a part of the convex surface of each of the plurality of first lenses is formed of a curved surface, the convex surface of each of the plurality of second lenses includes a second planar portion disposed at a center and a second curved portion disposed so as to surround the second planar portion in plan view, the second planar portion has a rectangular shape having a longitudinal direction and a transverse direction in plan view, the longitudinal direction of the second planar portion is the same direction as the longitudinal direction of the pixel aperture, and the transverse direction of the second planar portion is the same direction as the transverse direction of the pixel aperture.

A liquid crystal device according to another aspect of the present disclosure includes: a first substrate having a light transmissive property and including a plurality of pixel electrodes; a second substrate disposed so as to face the first substrate and including a lens layer; and a liquid crystal layer disposed between the first substrate and the second substrate, wherein the first substrate includes a plurality of pixel apertures which is disposed so as to correspond respectively to the plurality of pixel electrodes, and on which light from the lens layer is incident, each of the plurality of pixel apertures has a plurality of recessed portions recessed toward a center in plan view, the second substrate has a first surface on which the light is incident and a second surface from which the light is emitted, the lens layer includes a plurality of first lenses and a plurality of second lenses disposed so as to correspond respectively to the plurality of pixel electrodes, the plurality of first lenses is disposed at the first surface side of the second substrate, the plurality of second lenses is disposed at the second surface side with respect to the plurality of first lenses, the plurality of first lenses and the plurality of second lenses are arranged such that convex surfaces of the plurality of first lenses and convex surfaces of the plurality of second lenses face to respective sides opposite to each other, at least a part of the convex surface of each of the plurality of first lenses is formed of a curved surface, the convex surface of each of the plurality of second lenses includes a second planar portion disposed at a center and a second curved portion disposed so as to surround the second planar portion in plan view, and in the second planar portion, an outer edge at positions corresponding to the plurality of recessed portions is recessed toward a lens center in plan view.

Further, an electronic apparatus according to an aspect of the present disclosure includes the liquid crystal device according to any one of the aspects described above.

### BRIEF DESCRIPTION OF THE DRAWINGS

FIG. 1 is a schematic plan view showing a configuration of a liquid crystal device according to a first embodiment.

FIG. 2 is a schematic cross-sectional view along the line A-A' in FIG. 1.

FIG. 3A is a plan view showing an essential part of a lens and a pixel aperture according to the first embodiment.

FIG. 3B is a diagram showing an illuminance distribution of light according to the first embodiment.

FIG. 4A is a plan view showing an essential part of a lens and a pixel aperture according to a second embodiment.

FIG. 4B is a diagram showing an illuminance distribution of light according to the second embodiment.

FIG. 5 is a plan view showing an essential part of a lens and a pixel aperture according to a modified example of the second embodiment.

FIG. 6 is a plan view showing an essential part of a lens and a pixel aperture according to a third embodiment.

FIG. 7 is a schematic cross-sectional view corresponding to FIG. 2 according to the third embodiment.

FIG. 8 is a plan view showing an essential part of a lens and a pixel aperture according to a fourth embodiment.

FIG. 9 is a plan view showing an essential part of a lens and a pixel aperture according to a modified example of the fourth embodiment.

FIG. 10 is a schematic diagram showing a configuration of an electronic apparatus according to a fifth embodiment.

### DESCRIPTION OF EMBODIMENTS

An embodiment of the present disclosure will hereinafter be described with reference to the drawings. The present disclosure is not limited to the following embodiments, and includes various modified examples implemented within the scope of the present disclosure.

In each of the drawings described below, X, Y, and Z axes, which are coordinate axes perpendicular to one another, are given as necessary, a direction indicated by each of the arrows is defined as a positive (+) direction, and a direction opposite to the positive direction is defined as a negative (-) direction. In some cases, the +Z direction may be referred to as upward, and the -Z direction may be referred to as downward. In the drawings described below, in order to describe layers and members with recognizable sizes, the scales of the layers and the members are made different from actual ones.

Further, a plane including the X axis and the Y axis is also referred to as an X-Y plane, and a view of the X-Y plane from the +Z direction is referred to as a plan view. Further, for example, with respect to a substrate, the description "on a substrate" represents any one of when something is disposed in contact with the substrate, when something is indirectly disposed above the substrate with another structure intervening therebetween, and when something is disposed so that a part thereof is in contact with the substrate and another part thereof is disposed above the substrate with another structure intervening therebetween.

### First Embodiment

In the present embodiment, an active drive type liquid crystal device including a thin film transistor as a transistor for each pixel is exemplified as an electro-optical device. The thin film transistor is hereinafter abbreviated as "TFT". The liquid crystal device is suitable as, for example, a light modulation element (liquid crystal light valve) of a projection-type display apparatus as an electronic apparatus described later.

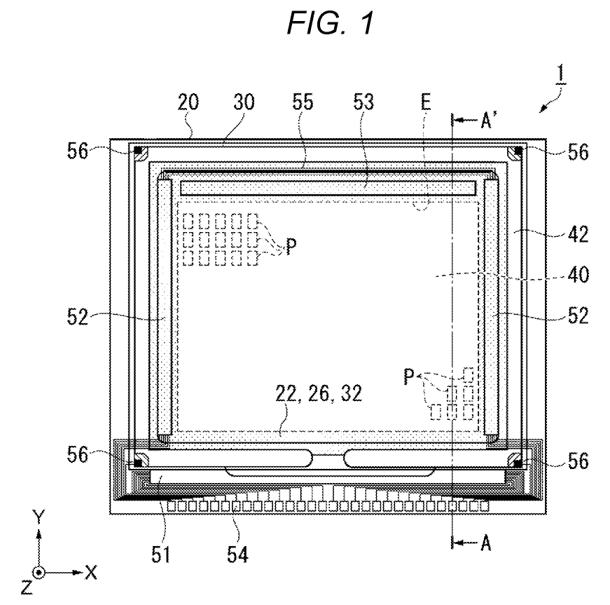

FIG. 1 is a schematic plan view showing a configuration of a liquid crystal device according to a first embodiment.

As illustrated in FIG. 1, the liquid crystal device 1 includes an element substrate 20 (first substrate), an opposed substrate 30 (second substrate), a seal member 42, and a liquid crystal layer 40. The opposed substrate 30 is disposed so as to be opposed to the element substrate 20. The liquid crystal layer 40 is disposed in a state of being interposed between the element substrate 20 and the opposed substrate 30. The element substrate 20 and the opposed substrate 30 are bonded to each other via the seal member 42 disposed in a frame shape along an edge portion of the opposed substrate 30.

The liquid crystal layer 40 is sealed in a space surrounded by the element substrate 20, the opposed substrate 30, and the seal member 42. The liquid crystal layer 40 is formed of liquid crystal which has positive or negative dielectric anisotropy. The seal member 42 is configured with an adhesive such as thermosetting epoxy resin or UV-curable epoxy resin.

A first light blocking layer 22 and a second light blocking layer 26 provided to the element substrate 20 and a third light blocking layer 32 provided to the opposed substrate 30 are disposed inside the seal member 42 disposed in the frame shape. Hereinafter, the first light blocking layer 22, the second light blocking layer 26, and the third light blocking layer 32 may be collectively referred to as light blocking layers 22, 26, and 32.

The light blocking layers 22, 26, and 32 each have a rim portion shaped like a frame and are formed of, for example, a light blocking metal or a metal oxide. The inside of each of the light blocking layers 22, 26, and 32 shaped like a frame is a display area E in which a plurality of pixels P is arranged. The pixels P each have, for example, a substantially rectangular shape and are arranged in a matrix.

The display area E is an area which substantially contributes to display in the liquid crystal device 1. The first light blocking layer 22 and the second light blocking layer 26 provided to the element substrate 20 are each disposed in, for example, a grid shape so as to two-dimensionally section the display area E into the plurality of pixels P.

At an opposite side to the display area E of the seal member 42 which is formed along a first side along the X axis of the element substrate 20, a data line drive circuit 51 and a plurality of external coupling terminals 54 are disposed along the first side. In addition, an inspection circuit 53 is provided at the display area E side of the display area E of the seal member 42 along a second side which is different from and opposed to the first side. Further, scan line drive circuits 52 are disposed at an inner side of the seal member 42 and along other two sides which are perpendicular to the first and second sides and are opposed to each other.

A plurality of wiring lines 55, which couples the two scan line drive circuits 52, is disposed at the display area E side of the seal member 42 on the second side along the Y axis on which the inspection circuit 53 is provided. The wiring lines which are coupled to the data line drive circuit 51 or the scan line drive circuit 52 are coupled to the plurality of external coupling terminals 54. Further, vertical conduction portions 56 for achieving electrical conduction between the element substrate 20 and the opposed substrate 30 are disposed on the corner portions of the opposed substrate 30.

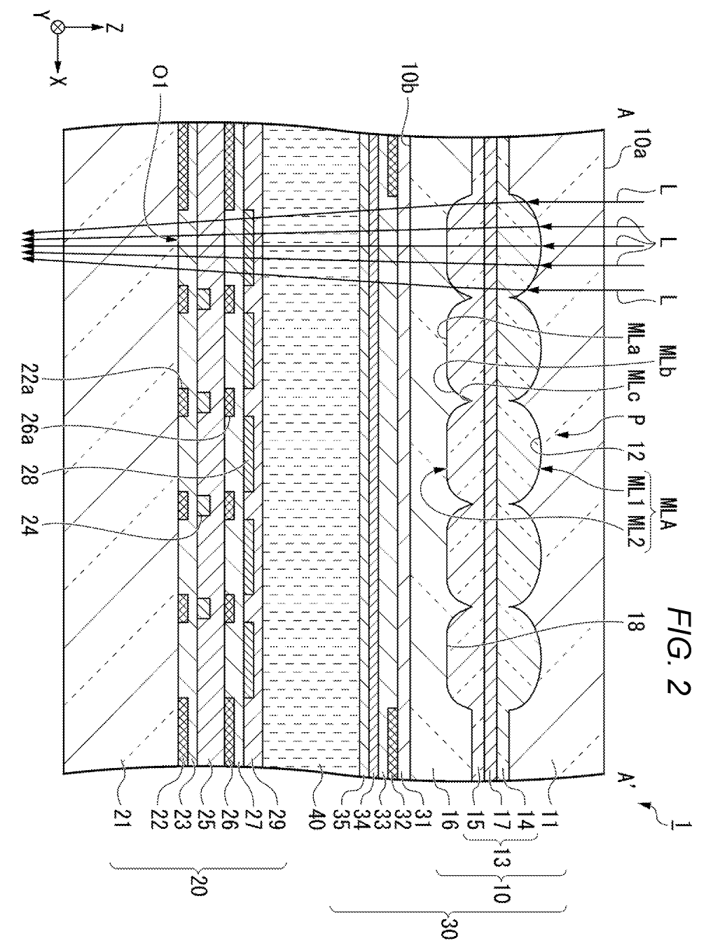

FIG. 2 is a schematic cross-sectional view along the line A-A' in FIG. 1.

As illustrated in FIG. 2, the opposed substrate 30 according to the first embodiment includes a microlens array unit 10, an optical path length adjustment layer 31, the third light blocking layer 32, a protective layer 33, a common electrode 34, and a second oriented film 35. The opposed substrate 30 has a light transmissive property.

The microlens array unit 10 includes a first base member 11, a lens layer 13, and a second base member 16. The microlens array unit 10 has a first surface 10a serving as a surface on which light is incident and a second surface 10b serving as a surface from which light is emitted. The first base member 11 is located at the extreme first surface 10a side of the microlens array unit 10. The first base member 11 has a plurality of first concave portions 12 formed at the second surface 10b side. The first base member 11 is formed of an inorganic material having a light transmissive property such as glass or quartz. Each of the first concave portions 12 is disposed so as to correspond to the pixel P. The plurality of first concave portions 12 is arranged such that the first concave portions 12 adjacent to each other in the X direction or the Y direction are in contact with each other. Accordingly, the first concave portions 12 adjacent to each other in the X direction or the Y direction are coupled to each other. The first concave portion 12 is formed corresponding to a shape of a microlens ML1 described later.

The lens layer 13 is formed integrally with the opposed substrate 30. The lens layer 13 is disposed at the second surface 10b side of the first base member 11. The lens layer 13 is made of a material having a light transmissive property and having a refractive index higher than those of the first base member 11 and the second base member 16. More specifically, the lens layer 13 is made of an inorganic material higher in optical refraction index than the first base member 11 and the second base member 16. Examples of such an inorganic material include SiON and Al₂O₃, and are appropriately selected as a combination of materials of the lens layer 13, the first base member 11, and the second base member 16. The lens layer 13 includes a first lens layer 14, a second lens layer 15, and a light transmissive material 17.

The first lens layer 14 is disposed at the extreme first surface 10a side of the lens layer 13. The first lens layer 14 is formed so as to fill the plurality of first concave portions 12. The first lens layer 14 has convex surfaces at the first surface 10a side. The first lens layer 14 is embedded in the first concave portions 12 to form a plurality of microlenses (first lenses) ML1 each having a convex surface at the first surface 10a side serving as the light incident side. Note that the first lens layer 14 having the convex surfaces may be formed first, and then the first base member 11 having the first concave portions 12 may be formed so as to fill the first lens layer 14.

The plurality of microlenses ML1 each has a circular shape in the plan view. Each of convex surfaces of the plurality of microlenses ML1 is formed of a curved surface. Note that each of the plurality of microlenses ML1 is only required to be at least partially formed of a curved surface, and may be formed of a planar portion and a curved portion as long as the microlens has a predetermined lens power.

The second lens layer 15 is disposed at the second surface 10b side with respect to the first lens layer 14. The second lens layer 15 is formed so as to fill a plurality of second concave portions 18 described later. The second lens layer 15 has convex surfaces at the second surface 10b side. That is, the first lens layer 14 and the second lens layer 15 are disposed such that the respective convex surfaces face to respective sides opposite to each other. The second lens layer 15 is embedded in the second concave portions 18 to thereby form a plurality of microlenses (second lenses) ML2 having convex surfaces at the second surface 10b side serving as a light exit side. The shape of the second lens layer 15 will be described later. Note that the second lens layer 15 having the convex surfaces may be formed first, and then the second base member 16 having the second concave portions 18 may be formed so as to fill the second lens layer 15.

The light transmissive material 17 is disposed between the first lens layer 14 and the second lens layer 15. The light transmissive material 17 is made of an inorganic material having a light transmissive property. Examples of such an inorganic material include SiON and Al₂O₃. The light transmissive material 17 functions as a planarization film and an optical path adjustment film. The thickness of the light transmissive material 17 is appropriately set in accordance with the wavelength of the light and based on optical conditions such as the focal lengths of the plurality of microlenses ML1 and the plurality of microlenses ML2. Further, the light transmissive material 17 may also serve as, for example, an adhesive for bonding the first lens layer 14 and the second lens layer 15 to each other. Note that the light transmissive material 17 may be omitted.

The second base member 16 is located at the extreme second surface 10b side of the microlens array unit 10. The second base member 16 has the plurality of second concave portions 18 formed at the first surface 10a side. The second base member 16 is formed of an inorganic material having the light transmissive property such as glass or quartz. Each of the second concave portions 18 is disposed so as to correspond to the pixel P. The plurality of second concave portions 18 is arranged such that the second concave portions 18 adjacent to each other in the X direction or the Y direction are in contact with each other. Accordingly, the second concave portions 18 adjacent to each other in the X direction or the Y direction are coupled to each other.

The second concave portions 18 are formed corresponding to the shape of the second lens layer 15. The microlenses ML2 are fitted into the second concave portions 18 formed so as to correspond to the shape of the microlenses ML2.

Therefore, the lens layer 13 includes the plurality of microlenses ML1 and the plurality of microlenses ML2 disposed so as to correspond respectively to the plurality of pixels P. Further, a microlens array MLA is configured with the first lens layer 14 and a plurality of second lens layers 15.

The optical path length adjustment layer 31 is disposed so as to cover the microlens array unit 10. The optical path length adjustment layer 31 is made of an inorganic material that has a light transmissive property and has a refractive index substantially the same as that of, for example, the first base member 11. The optical path length adjustment layer 31 has a function of adjusting a distance from the microlens ML1 and the microlens ML2 to the second light blocking layer 26 to a desired value. Therefore, the layer thickness of the optical path length adjustment layer 31 is appropriately set based on optical conditions such as the focal lengths of the microlenses ML1 and the microlenses ML2 in accordance with the wavelength of the light.

The third light blocking layer 32 is disposed at the optical path length adjustment layer 31. The third light blocking layer 32 is disposed so as to surround the display area E (see FIG. 1) in which the microlenses ML1 and the microlenses ML2 are arranged. The third light blocking layer 32 may be disposed inside the display area E, and may be formed in a grid pattern, an island shape, a stripe shape, or the like, so as to overlap the first light blocking layer 22 and the second light blocking layer 26 of the element substrate 20 in the plan view.

The protective layer 33 is disposed so as to cover the optical path length adjustment layer 31 and the third light blocking layer 32. The common electrode 34 is disposed so as to cover the protective layer 33. The common electrode 34 is formed across the plurality of pixels P. The common electrode 34 is formed of a transparent conductive film such as indium tin oxide (ITO) or indium zinc oxide (IZO). The second oriented film 35 is disposed so as to cover the common electrode 34.

The element substrate 20 includes a third base member 21, the first light blocking layer 22, a first insulating layer 23, TFTs 24, a second insulating layer 25, the second light blocking layer 26, a third insulating layer 27, pixel electrodes 28, and a first oriented film 29. The third base member 21 is made of a material having a light transmissive property such as glass or quartz.

The first light blocking layer 22 is disposed at the third base member 21. The first light blocking layer 22 is formed in a grid shape so as to overlap the second light blocking layer 26 as an upper layer in the plan view. The first light blocking layer 22 and the second light blocking layer 26 are disposed so as to sandwich the TFT 24 therebetween in the thickness direction of the element substrate 20 (Z direction). The first light blocking layer 22 overlaps at least a channel region of each of the TFTs 24 in the plan view.

By providing the first light blocking layer 22 and the second light blocking layer 26, the light is prevented from entering the TFTs 24. An inside of a first aperture 22a as a region surrounded by the first light blocking layer 22 and an inside of a second aperture 26a as a region surrounded by the second light blocking layer 26 overlap each other in the plan view to form a region through which the light is transmitted. In the pixel P, a region overlapping the first aperture 22a and the second aperture 26a in the plan view is a pixel aperture O1, and is a region that transmits the light. The pixel aperture O1 is disposed in substantially parallel to a plane including the X direction and the Y direction.

The first insulating layer 23 is disposed so as to cover the third base member 21 and the first light blocking layer 22. The first insulating layer 23 is made of an inorganic material such as SiO₂.

The TFTs 24 are disposed at the first insulating layer 23. The TFTs 24 are each a switching element that drives the pixel electrode 28. The TFT 24 includes a semiconductor layer, a gate electrode, a source electrode, and a drain electrode (all not shown).

The second insulating layer 25 is disposed so as to cover the first insulating layer 23 and the TFTs 24. The second insulating layer 25 is made of an inorganic material such as SiO₂. The second insulating layer 25 includes a gate insulating film that insulates the semiconductor layer and the gate electrode of the TFT 24 from each other. The second insulating layer 25 eases the unevenness of a surface caused by the TFTs 24. A second light blocking layer 26 is disposed at the second insulating layer 25. Further, the third insulating layer 27 made of an inorganic material is disposed so as to cover the second insulating layer 25 and the second light blocking layer 26.

Each of the pixel electrodes 28 is disposed at the third insulating layer 27 so as to correspond to each of the pixels P. The pixel electrode 28 is disposed in a region overlapping the pixel aperture O1 described above of each of the pixels P in the plan view. The pixel electrode 28 is formed of a transparent conductive film such as indium tin oxide (ITO) or indium zinc oxide (IZO). The first oriented film 29 is disposed so as to cover the pixel electrodes 28. The liquid crystal layer 40 is encapsulated between the first oriented film 29 at the element substrate 20 side and the second oriented film 35 at the opposed substrate 30 side.

The microlenses ML1 and the microlenses ML2 are disposed so as to correspond respectively to the pixel electrodes 28. Similarly, the pixel apertures O1 are disposed so as to correspond respectively to the pixel electrodes 28.

Note that the TFT 24, and an electrode, a wiring line, and so on (not illustrated) that supply an electric signal to the TFT 24 are disposed in a region overlapping the first light blocking layer 22 and the second light blocking layer 26 in the plan view. These electrodes, wiring lines, and so on may be configured to also serve as the first light blocking layer 22 or the second light blocking layer 26.

In the liquid crystal device 1 according to the first embodiment, the light emitted from, for example, a light source is incident from the first surface 10a of the opposed substrate 30, is condensed by each of the microlenses ML1 and each of the microlenses ML2 of the microlens array unit 10 including the lens layer 13, and is incident on the corresponding one of the pixel apertures O1.

As illustrated in FIG. 2, since the microlens ML1 has predetermined lens power, incident light L incident on the microlens ML1 is refracted toward the center of the pixel P. The incident light L thus refracted is incident on the microlens ML2. Accordingly, the incident light L is efficiently incident on the microlens ML2 by being condensed by the microlens ML1.

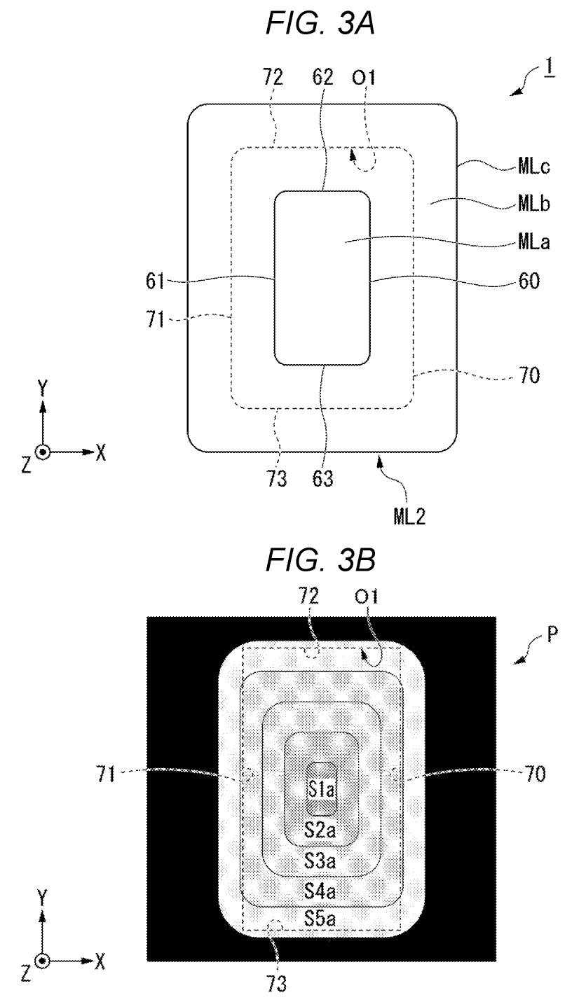

Then, a correspondence relationship between the shape of the microlens ML2 and the shape of the pixel aperture O1, and an action by having that correspondence relationship will be described with reference to FIGS. 3A and 3B. FIG. 3A is a plan view illustrating the pixel aperture O1 and an essential part of a microlens ML2 disposed at the pixel aperture O1.

As indicated by a dashed line in FIG. 3A, the pixel aperture O1 has a substantially rectangular planar shape.

As indicated by a solid line in FIG. 3A, the microlens ML2 includes a second planar portion MLa disposed in a central portion, a second curved portion MLb disposed around the second planar portion MLa, and a second rim portion MLc in the plan view. The second planar portion MLa and the second curved portion MLb are formed continuously. The second planar portion MLa has a rectangular planar shape. Four corners of the rectangular shape of the second planar portion MLa are not right angles but are rounded.

The second planar portion MLa is a tip portion of the microlens ML2 and has a substantially rectangular planar shape. The second rim portion MLc has a rectangular planar shape, and each of four corners thereof is rounded.

The second planar portion MLa has a longitudinal direction along the Y direction and a transverse direction along the X direction in the plan view. The sides along the longitudinal direction are longer than the sides along the transverse direction. The second planar portion MLa is configured with second long sides 60, 61 along the longitudinal direction and second short sides 62, 63 along the transverse direction in the plan view. The second long sides 60, 61 are arranged in order in the +X direction. The second short sides 62, 63 are arranged in order in the +Y direction.

Note that the longitudinal direction and the transverse direction may be a longitudinal direction along the X direction and a transverse direction along the Y direction, respectively.

The second planar portion MLa is a substantially flat surface substantially parallel to the first surface 10a of the microlens array unit 10. The second planar portion MLa does not have lens power. Therefore, the incident light L incident on the second planar portion MLa travels with the optical path not significantly changed. The incident light L incident on the second planar portion MLa located in the central portion of the pixel P is transmitted through the central portion of the pixel aperture O1 without being blocked by the second light blocking layer 26, and is emitted toward the element substrate 20.

Therefore, the incident light L transmitted through the second planar portion MLa forms a rectangular illumination region substantially similar to the second planar portion MLa in the pixel aperture O1.

The second curved portion MLb is disposed continuously with the second planar portion MLa, and is configured with a lens surface having a predetermined curvature. The second curved portion MLb has predetermined lens power. Therefore, the incident light L incident on the second curved portion MLb of the microlens ML2 is refracted toward the center of the pixel P. Therefore, the second curved portion MLb converges the incident light L toward the planar center of the pixel P. Therefore, the incident light L is favorably incident on the second aperture 26a of the second light blocking layer 26, and can pass through the pixel aperture O1 of each of the pixels P.

Since the second curved portion MLb is disposed so as to surround the second planar portion MLa, the light condensed by the second curved portion MLb is converged so as to follow the periphery of the light transmitted through the second planar portion MLa. Therefore, the light transmitted through the second curved portion MLb forms an illumination region concentrically surrounding the second planar portion MLa inside the pixel aperture O1.

The second rim portion MLc forms the outer shape of the microlens ML2. The second rim portion MLc is substantially similar in shape to the second planar portion MLa in the plan view. In the present specification, the expression that the second rim portion MLc and the outer shape are substantially similar to each other is not limited to when the shapes are completely the same as each other, and also includes an aspect in which the aspect ratios of the overall outer shapes are equal to each other and the shapes are different in details from each other.

The pixel aperture O1 is a region through which the light is transmitted when viewed from a direction along the Z direction. The pixel aperture O1 has a rectangular shape in the plan view. In addition, in each of the four corners of the pixel aperture O1, a convex portion may be formed toward the region through which the light is transmitted.

The pixel aperture O1 has a longitudinal direction along the Y direction and a transverse direction along the X direction in the plan view. The sides along the longitudinal direction are longer than the sides along the transverse direction. The pixel aperture O1 is configured with the long sides 70, 71 along the longitudinal direction and the short sides 72, 73 along the transverse direction in the plan view. The long sides 70, 71 are arranged in order in the +X direction. The short sides 72, 73 are arranged in order in the +Y direction.

Note that the longitudinal direction and the transverse direction may be a longitudinal direction along the X direction and a transverse direction along the Y direction, respectively.

The longitudinal direction in the second planar portion MLa is the same direction as the longitudinal direction in the pixel aperture O1. More specifically, the second long side 60 in the second planar portion MLa corresponds to the long side 70 in the pixel aperture O1. The second long side 61 in the second planar portion MLa corresponds to the long side 71 in the pixel aperture O1.

Similarly, the transverse direction in the second planar portion MLa is the same direction as the transverse direction in the pixel aperture O1. More specifically, the second short side 62 in the second planar portion MLa corresponds to the short side 72 in the pixel aperture O1. The second short side 63 in the second planar portion MLa corresponds to the short side 73 in the pixel aperture O1.

The second planar portion MLa and the pixel aperture O1 are equal in aspect ratio, which is a ratio between a size in the longitudinal direction and a size in the transverse direction, and are substantially similar to each other in the plan view. The second planar portion MLa is smaller in area than the pixel aperture O1 in the plan view. The second planar portion MLa is located inside the pixel aperture O1 in the plan view. Therefore, the incident light L can surely be incident on the pixel aperture O1.

Then, an illuminance distribution formed on the pixel aperture O1 by the microlens array MLA according to the first embodiment will be described. FIG. 3B is a diagram schematically illustrating the illuminance distribution in the pixel aperture O1. In FIG. 3B, the illuminance of the light incident on the pixel aperture O1 is shown in five stages of S1a, S2a, S3a, S4a, and S5a, wherein S1a is the highest in illuminance, and the illuminance decreases in the order of S2a, S3a, S4a, and S5a. As illustrated in FIG. 3B, in the microlens ML2 according to the first embodiment, the illuminance gradually decreases from the central portion of the microlens ML2 toward the second curved portion MLb and toward the second rim portion MLc.

As described above, the liquid crystal device 1 of the present embodiment includes the element substrate 20 having a light transmissive property and including the plurality of pixel electrodes 28, the opposed substrate 30 disposed so as to face the element substrate 20 and including the lens layer 13, and the liquid crystal layer 40 disposed between the element substrate 20 and the opposed substrate 30, the element substrate 20 has the plurality of pixel apertures O1 which is disposed so as to correspond respectively to the plurality of pixel electrodes 28 and on which the light from the lens layer 13 is incident, each of the plurality of pixel apertures O1 has the rectangular shape having the longitudinal direction and the transverse direction in the plan view, the opposed substrate 30 has the first surface 10a on which the light is incident and the second surface 10b from which the light is emitted, the lens layer 13 has the first lens layer 14 and the second lens layer 15 disposed so as to correspond to each of the plurality of pixel electrodes 28, the first lens layer 14 is disposed at the first surface 10a side of the opposed substrate 30, the second lens layer 15 is disposed at the second surface 10b side with respect to the first lens layer 14, the first lens layer 14 and the second lens layer 15 are disposed so that the respective convex surfaces face to the respective sides opposite to each other, each of the convex surfaces of the first lens layer 14 is at least partially formed of a curved surface, each of the convex surfaces of the second lens layer 15 has the second planar portion MLa disposed at the center and the second curved portion MLb disposed so as to surround the second planar portion MLa in the plan view, the second planar portion MLa has the rectangular shape having the longitudinal direction and the transverse direction in the plan view, the longitudinal direction of the second planar portion MLa is the same direction as the longitudinal direction of the pixel aperture O1, and the transverse direction of the second planar portion MLa is the same direction as the transverse direction of the pixel aperture O1.

According to the liquid crystal device 1 of the present embodiment, the microlens ML1 which is a first microlens formed of a curved surface and the microlens ML2 which is a second microlens and in which the shape of the second planar portion MLa matches the shape of the pixel aperture O1 are provided. The light incident on each of the pixels P is condensed by the microlens ML1 as the first microlens and is efficiently incident on the microlens ML2 as the second microlens. Since the microlens ML2 has the shape in which the shape of the second planar portion MLa matches the shape of the pixel aperture O1, although a part of the light in S5a the lowest in illuminance irradiates an outside of the pixel aperture O1, an inside of the pixel aperture O1 can be irradiated with the light in S1a, S2a, S3a, and S4a higher in illuminance than S5a. Therefore, compared to when the shape of the second planar portion MLa is different from the shape of the pixel aperture O1, the light with which the surrounding area of the long sides 70, 71 corresponding to the longitudinal direction of the pixel aperture O1 is irradiated can be decreased. That is, the microlens ML2 can prevent the first light blocking layer 22 and the second light blocking layer 26 constituting the edge portion of the pixel aperture O1 from being irradiated with the light. As described above, the light is condensed by the microlens ML1 as the first microlens and is condensed by the microlens ML2 as the second microlens in accordance with the shape of the pixel aperture O1. Therefore, since the liquid crystal device 1 of the present embodiment can condense the light in two stages, that is, the microlens ML1 and the microlens ML2, it is possible to make a larger amount of light be incident on the pixel aperture O1. Therefore, the amount of light emitted from the element substrate 20 side can be increased, and the light use efficiency can be increased.

### Second Embodiment

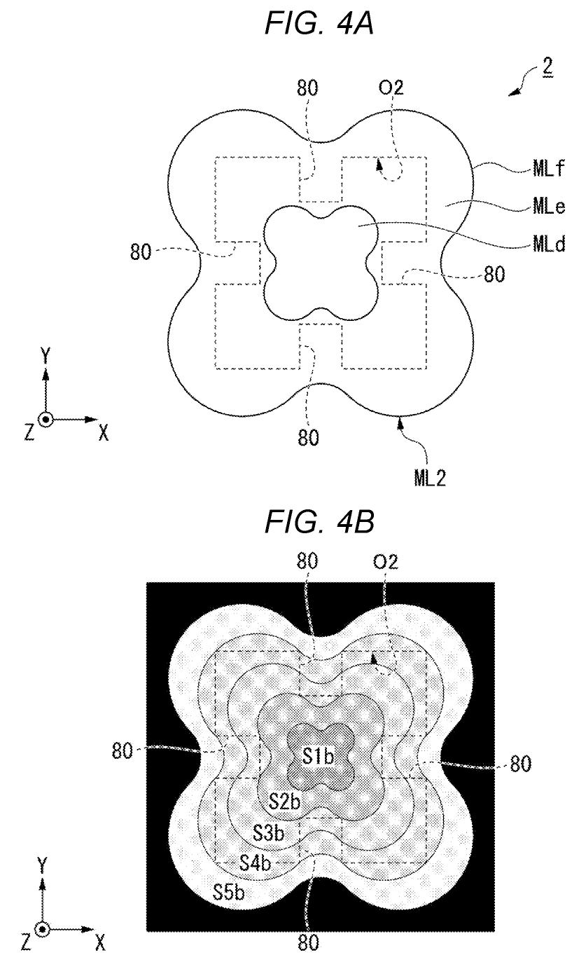

A liquid crystal device 2 according to a second embodiment of the present disclosure will hereinafter be described with reference to FIGS. 4A and 4B. The basic configuration of the liquid crystal device 2 of the present embodiment is the same as that of the first embodiment, and the shapes of the microlenses and the pixel apertures are different from those of the first embodiment. In FIGS. 4A and 4B, components common to those in the drawings used in the first embodiment are provided with the same reference symbols to omit the description thereof.

FIG. 4A is a plan view illustrating a pixel aperture O2 and an essential part of the microlens ML2 disposed on the pixel aperture O2. The shape of the pixel aperture O2 in the second embodiment is indicated by a dashed line. Similarly to the first embodiment, in the pixel P, the pixel aperture O2 is a region overlapping the first aperture 22a and the second aperture 26a in the plan view.

The pixel aperture O2 is a region through which the light is transmitted when viewed from a direction along the Z direction. The pixel aperture O2 has opening recesses 80 (recessed portions), which are each a recess recessed toward the center to form a quadrangular shape, in respective central portions of the four sides of a square in the plan view. The opening recess 80 is configured with a convex portion which is formed by the first light blocking layer 22 protruding toward the center of the first aperture 22a and the second light blocking layer 26 protruding toward the center of the second aperture 26a. Thus, the convex portion forms the opening recess 80 in which a part of each of edge portions in the pixel aperture O2 is recessed toward the center in the plan view. In addition, in each of the four corners of the pixel aperture O2, the convex portions may be formed toward the region through which the light is transmitted.

Note that it is sufficient for the opening recesses 80 to be formed on at least two or more sides out of the four sides of the square. The pixel aperture O2 may have a side on which the opening recess 80 is not formed.

As illustrated in FIG. 2, since the microlens ML1 has predetermined lens power, incident light L incident on the microlens ML1 is refracted toward the center of the pixel P. The incident light L thus refracted is efficiently incident on the microlens ML2. Accordingly, the incident light L is efficiently incident on the microlens ML2 by being condensed by the microlens ML1.

Then, a correspondence relationship between the shape of the microlens ML2 and the shape of the pixel aperture O2, and an action by having that correspondence relationship will be described with reference to FIGS. 4A and 4B. In FIG. 4A, the lens shape of the microlens ML2 is indicated by a solid line. The lens shape of the microlens ML2 is a shape in which vertexes of the square are rounded and each of the sides is recessed toward the center as a whole.

As indicated by the solid line in FIG. 4A, the microlens ML2 includes a second planar portion MLd disposed in a central portion, a second curved portion MLe disposed around the second planar portion MLd, and a second rim portion MLf in the plan view. The second planar portion MLd and the second curved portion MLe are formed continuously. The second planar portion MLd is formed such that four sides are recessed toward the lens center and four corners are each formed to have a circular shape toward the outside in the plan view. The four sides in the second planar portion MLd are formed symmetrically in the vertical and horizontal directions. The four corners of the second planar portion MLd are formed similarly to each other. The second planar portion MLd is a convex portion of the microlens ML2.

The second planar portion MLd is a surface which is substantially flat and is substantially parallel to the first surface 10a of the microlens array unit 10. The second planar portion MLd has a shape corresponding to the shape of the pixel aperture O2. More specifically, the second planar portion MLd is recessed in a rounded shape at a position corresponding to the opening recess 80 of the pixel aperture O2 in the plan view. The second planar portion MLd does not have lens power. Therefore, the incident light L incident on the second planar portion MLd travels with the optical path not significantly changed. The incident light L incident on the second planar portion MLd located in the central portion of the pixel P is transmitted through the central portion of the pixel aperture O2 without being blocked by the second light blocking layer 26, and is emitted toward the element substrate 20.

Therefore, the incident light L transmitted through the second planar portion MLd forms an illumination region having a shape substantially similar to the second planar portion MLd in the pixel aperture O2.

The second curved portion MLe is disposed continuously with the second planar portion MLd, and is configured with a lens surface having a predetermined curvature. The second curved portion MLe has predetermined lens power. Therefore, the incident light L incident on the second curved portion MLe of the microlens ML2 is refracted toward the center of the pixel P. Therefore, the second curved portion MLe converges the incident light L toward the planar center of the pixel P. Therefore, the incident light L is favorably incident on the second aperture 26a of the second light blocking layer 26, and can pass through the pixel aperture O2 of each of the pixels P.

Since the second curved portion MLe is disposed so as to surround the second planar portion MLd, the light condensed by the second curved portion MLe is converged so as to follow the periphery of the light transmitted through the second planar portion MLd. Therefore, the light transmitted through the second curved portion MLe forms an illumination region concentrically surrounding the second planar portion MLd inside the pixel aperture O2.

The second rim portion MLf forms the outer shape of the microlens ML2. The second rim portion MLf is substantially similar in shape to the second planar portion MLd in the plan view.

The second planar portion MLd is smaller in area than the pixel aperture O2 in the plan view. The second planar portion MLd is located inside the pixel aperture O2 in the plan view. Therefore, the incident light L can surely be incident on the pixel aperture O2.

Then, an illuminance distribution formed on the pixel aperture O2 by the microlens ML2 according to the present embodiment will be described. FIG. 4B is a diagram schematically illustrating the illuminance distribution in the pixel aperture O2. In FIG. 4B, the illuminance is shown in five stages of S1b, S2b, S3b, S4b, and S5b, wherein S1b is the highest in illuminance, and the illuminance decreases in the order of S2b, S3b, S4b, and S5b. As illustrated in FIG. 4B, in the microlens ML2 according to the second embodiment, the illuminance gradually decreases from the central portion (the second planar portion MLd) of the microlens ML2 toward the second curved portion MLe and toward the second rim portion MLf.

As described above, the liquid crystal device 2 of the present embodiment includes the element substrate 20 having a light transmissive property and including the plurality of pixel electrodes 28, the opposed substrate 30 disposed so as to face the element substrate 20 and including the lens layer 13, and the liquid crystal layer 40 disposed between the element substrate 20 and the opposed substrate 30, the element substrate 20 has the plurality of pixel apertures O2 which is disposed so as to correspond respectively to the plurality of pixel electrodes 28 and on which the light from the lens layer 13 is incident, each of the plurality of pixel apertures O2 has the plurality of opening recesses 80 recessed toward the center in the plan view, the opposed substrate 30 has the first surface 10a on which the light is incident and the second surface 10b from which the light is emitted, the lens layer 13 has the first lens layer 14 and the second lens layer 15 disposed so as to correspond to each of the plurality of pixel electrodes 28, the first lens layer 14 is disposed at the first surface 10a side of the opposed substrate 30, the second lens layer 15 is disposed at the second surface 10b side with respect to the first lens layer 14, the first lens layer 14 and the second lens layer 15 are disposed so that the respective convex surfaces face to the respective sides opposite to each other, each of the convex surfaces of the first lens layer 14 is at least partially formed of a curved surface, each of the convex surfaces of the second lens layer 15 has the second planar portion MLd disposed at the center and the second curved portion MLe disposed so as to surround the second planar portion MLd in the plan view, and in the second planar portion MLd, the outer edge at the positions corresponding to the plurality of opening recesses 80 is recessed toward the lens center in the plan view.

According to the liquid crystal device 2 of the present embodiment, the microlens ML1 which is a first microlens formed of a curved surface and the microlens ML2 which is a second microlens and in which the shape of the second planar portion MLd matches the shape of the pixel aperture O2 are provided. The light incident on each of the pixels P is condensed by the microlens ML1 as the first microlens and is efficiently incident on the microlens ML2 as the second microlens. The second planar portion MLd has a shape in which the outer edge at the position corresponding to the opening recess 80 of the pixel aperture O2 is recessed toward the lens center in the plan view. Therefore, among the light incident on the microlens ML2, the light in S5b the lowest in illuminance is emitted to the outside of the pixel aperture O2, but an inside of the pixel aperture O2 is irradiated with the light in S1b, S2b, and S3b higher in illuminance than S5a. Further, the inside of the pixel aperture O2 is also irradiated with most of the light in S4b. Therefore, the microlens ML2 of the present embodiment can reduce the light with which the periphery of the pixel aperture O2 is irradiated compared to when the shape of the second planar portion MLd is different from the shape of the pixel aperture O2. That is, the microlens array MLA can prevent the first light blocking layer 22 and the second light blocking layer 26 constituting the edge portion of the pixel aperture O2 from being irradiated with the light. As described above, the light is condensed by the microlens ML1 as the first microlens and is condensed by the microlens ML2 as the second microlens in accordance with the shape of the pixel aperture O2. Therefore, since the liquid crystal device 2 of the present embodiment can condense the light in two stages, that is, the microlens ML1 and the microlens ML2, it is possible to make a larger amount of light be incident on the pixel aperture O2. Therefore, the amount of light emitted from the element substrate 20 side can be increased, and the light use efficiency can be increased.

### Modified Examples

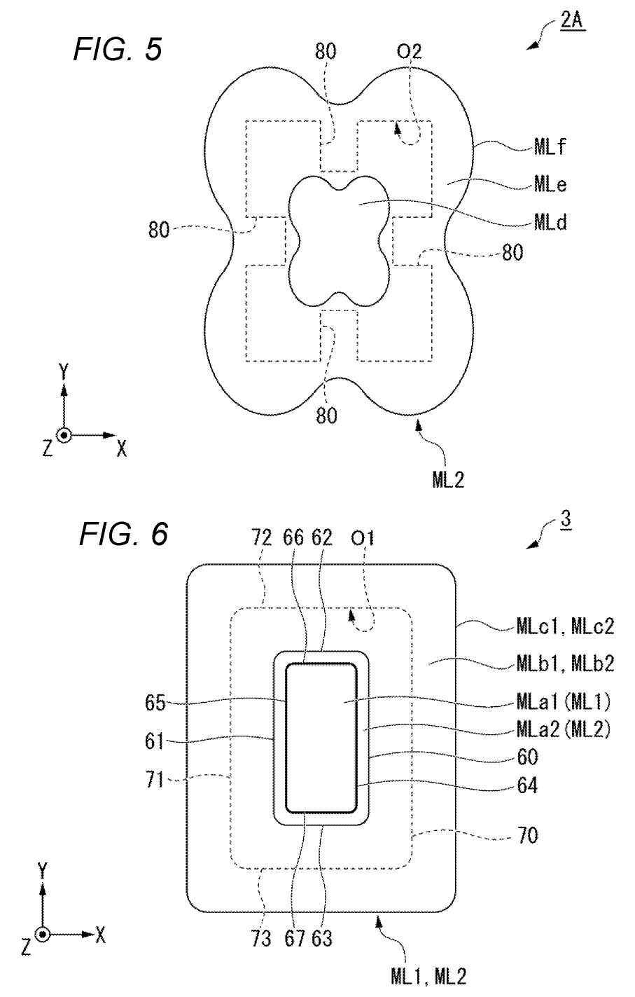

FIG. 5 shows a liquid crystal device 2A according to a modified example of the present embodiment. FIG. 5 is a plan view illustrating an essential part of a lens and a pixel aperture according to the modified example of the second embodiment. In the second embodiment, the pixel aperture O2 having the opening recesses 80 and the second planar portion MLd corresponding to the shape of the pixel aperture O2 have been described. However, as illustrated in FIG. 5, the pixel aperture O1 of the first embodiment may be applied to the pixel aperture O2 of the second embodiment. Similarly, the second planar portion MLa of the first embodiment may be applied to the second planar portion MLd of the second embodiment.

As described above, the second planar portion MLd has a shape in which the outer edge at the position corresponding to the opening recess 80 of the pixel aperture O2 is recessed toward the lens center, and has the longitudinal direction and the transverse direction. Therefore, even when the pixel aperture O2 has the opening recesses 80 and has a rectangular shape, the shape of the second planar portion MLd is a shape according to the shape of the pixel aperture O2.

Therefore, the first light blocking layer 22 and the second light blocking layer 26 constituting the edge portion of the pixel aperture O2 can be prevented from being irradiated with the light. Therefore, since it is possible to make a larger amount of light be incident on the pixel aperture O2 from the microlens ML2, the light use efficiency can be increased.

### Third Embodiment

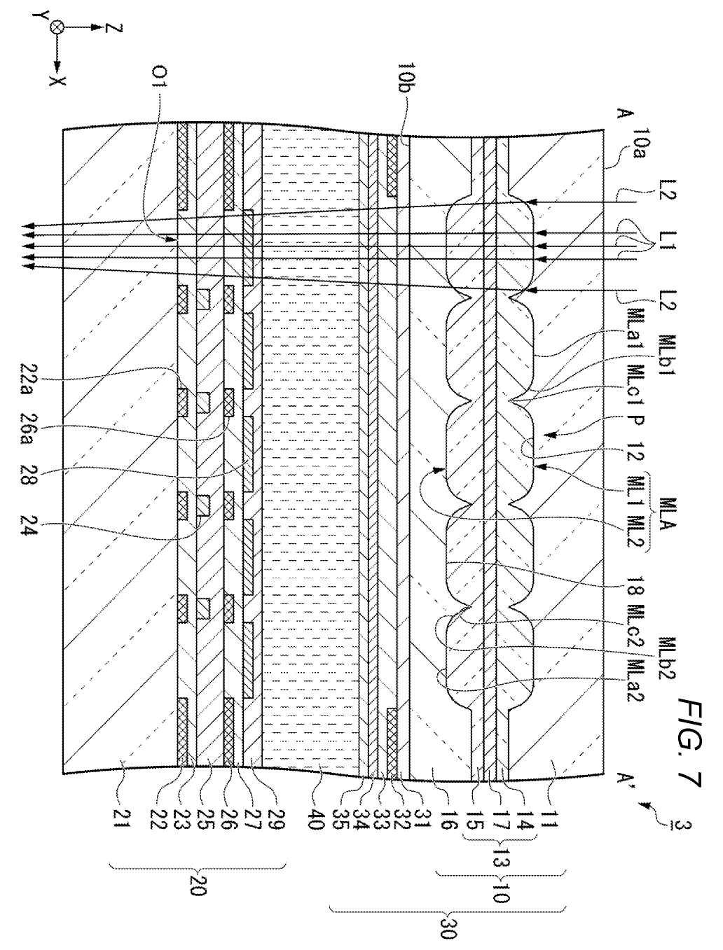

A third embodiment of the present disclosure will hereinafter be described with reference to FIGS. 6 and 7. The present embodiment is substantially the same in basic configuration of the liquid crystal device 3 as the first embodiment, and is different in configuration of a first lens from the first embodiment. In FIGS. 6 and 7, components common to those in the drawings used in the first embodiment are denoted by the same reference symbols to omit the description thereof.

FIG. 6 is a plan view illustrating the pixel aperture O1 and an essential part of the microlens ML1 and the microlens ML2 disposed at the pixel aperture O1 in the third embodiment. FIG. 7 is a diagram illustrating a cross-sectional configuration of a liquid crystal device 3 according to the third embodiment. FIG. 7 is a schematic cross-sectional view corresponding to FIG. 2 in the first embodiment.

As illustrated in FIG. 6, the microlens ML1 of the present embodiment has substantially the same configuration as the microlens ML2 as a whole, and includes a first planar portion MLa1 disposed in a central portion, a first curved portion MLb1 disposed around the first planar portion MLa1, and a first rim portion MLc1 in the plan view. The first planar portion MLa1 and the first curved portion MLb1 are formed continuously. The first planar portion MLa1 has a rectangular planar shape. Four corners of the rectangular shape of the first planar portion MLa1 are not right angles but are rounded.

The first planar portion MLa1 is a tip portion of the microlens ML1 and has a substantially rectangular planar shape. The first rim portion MLc1 has a rectangular planar shape, and each of four corners thereof is formed to have a rounded shape.

The first planar portion MLa1 has a longitudinal direction along the Y direction and a transverse direction along the X direction in the plan view. The sides along the longitudinal direction are longer than the sides along the transverse direction. The first planar portion MLa1 is configured with first long sides 64, 65 along the longitudinal direction and first short sides 66, 67 along the transverse direction in the plan view. The first long sides 64, 65 are arranged in order in the +X direction. The first short sides 66, 67 are arranged in order in the +Y direction.

Note that the longitudinal direction and the transverse direction may be a longitudinal direction along the X direction and a transverse direction along the Y direction, respectively.

The first rim portion MLc1 forms the outer shape of the microlens ML1. The first rim portion MLc1 is substantially similar in shape to the first planar portion MLa1 in the plan view.

The longitudinal direction in the first planar portion MLa1 is the same direction as the longitudinal direction in the pixel aperture O1. More specifically, the first long side 64 in the first planar portion MLa1 corresponds to the long side 70 in the pixel aperture O1. The first long side 65 in the first planar portion MLa1 corresponds to the long side 71 in the pixel aperture O1.

Similarly, the transverse direction in the first planar portion MLa1 is the same direction as the transverse direction in the pixel aperture O1. More specifically, the first short side 66 in the first planar portion MLa1 corresponds to the short side 72 in the pixel aperture O1. The first short side 67 in the first planar portion MLa1 corresponds to the short side 73 in the pixel aperture O1.

The first planar portion MLa1 and the pixel aperture O1 are equal in aspect ratio, which is a ratio between a size in the longitudinal direction and a size in the transverse direction, and are substantially similar to each other in the plan view. The first planar portion MLa1 is smaller in area than the pixel aperture O1 in the plan view. The first planar portion MLa1 is located inside the pixel aperture O1 in the plan view. Therefore, incident light L1 can surely be incident on the pixel aperture O1.

As shown in FIG. 7, the first planar portion MLa1 is a substantially flat surface substantially parallel to the first surface 10a of the microlens array unit 10. The first planar portion MLa1 does not have lens power. Therefore, the incident light L1 incident on the first planar portion MLa1 travels with the optical path not significantly changed. As described above, the incident light L1 transmitted through the first planar portion MLa1 is incident on the second planar portion MLa2 of the microlens ML2.

The first planar portion MLa1 is substantially similar in shape to the second planar portion MLa2. The first planar portion MLa1 has a smaller plane area than the second planar portion MLa2 in the plan view.

A part of the light incident on the first planar portion MLa1 is emitted so as to spread to the outside of the microlens ML1 due to, for example, diffraction of the light. Therefore, when the first planar portion MLa1 and the second planar portion MLa2 are the same in size, the component of the light thus spread spreads out of the second planar portion MLa2, and thus, the component incident on the second planar portion MLa2 is reduced. As a result, the amount of light incident on the second planar portion MLa2 decreases, and the illuminance in the pixel aperture O1 may become dark in some cases.

In contrast, by making the plane area of the second planar portion MLa2 located at the light exit side larger than the plane area of the first planar portion MLa1 located at the light incident side, even the light spreading outside the microlens ML1 can be made incident on the second planar portion MLa2. Thus, the decrease in illuminance in the pixel aperture O1 can be suppressed.

The first curved portion MLb1 is disposed continuously to the first planar portion MLa1, and is configured with a lens surface having a predetermined curvature. The first curved portion MLb1 has predetermined lens power. Therefore, the incident light L2 incident on the first curved portion MLb1 is refracted toward the center of the pixel P. Therefore, the first curved portion MLb1 converges the incident light L2 toward the planar center of the pixel P. As described above, the incident light L2 condensed by the first curved portion MLb1 is incident on the microlens ML2 in a converged state.

Further, the second planar portion MLa2 at the microlens ML2 side does not have lens power. Therefore, the incident light L1 incident on the second planar portion MLa2 travels with the optical path not significantly changed. The incident light L1 incident on the second planar portion MLa2 located in the central portion of the pixel P is transmitted through the central portion of the pixel aperture O1 without being blocked by the second light blocking layer 26, and is emitted toward the element substrate 20. Therefore, the incident light L1 transmitted through the second planar portion MLa2 forms a rectangular illumination region substantially similar to the second planar portion MLa2 in the pixel aperture O1.

Meanwhile, the incident light L2 incident on the second curved portion MLb2 is refracted toward the center of the pixel P and is converged toward the planar center of the pixel P. Therefore, due to the action of the microlenses ML1 and ML2, the light can be efficiently incident on the pixel aperture O1 of each of the pixels P through the second aperture 26a of the second light blocking layer 26.

Since the second curved portion MLb2 is disposed so as to surround the second planar portion MLa2, the light condensed by the second curved portion MLb2 is converged so as to follow the periphery of the light transmitted through the second planar portion MLa2. Therefore, the light transmitted through the second curved portion MLb2 forms an illumination region concentrically surrounding the second planar portion MLa2 inside the pixel aperture O1.

Therefore, the incident light L2 is favorably incident on the second aperture 26a of the second light blocking layer 26, and can pass through the pixel aperture O1 of each of the pixels P.

In the liquid crystal device 3 according to the third embodiment, the light emitted from, for example, a light source is incident from the first surface 10a of the opposed substrate 30, is condensed by each of the microlenses ML1 and each of the microlenses ML2 of the microlens array unit 10 including the lens layer 13, and is efficiently incident on the corresponding one of the pixel apertures O1. Therefore, it is possible to reduce the light with which the periphery of the pixel aperture O1 is irradiated. Therefore, the first light blocking layer 22 and the second light blocking layer 26 constituting the edge portion of the pixel aperture O1 can be prevented from being irradiated with the light. Therefore, similarly to the first embodiment, it is possible to provide the liquid crystal device 3 and the electronic apparatus having the advantage of increasing the light use efficiency by increasing the amount of light emitted from the element substrate 20 side.

As described above, the liquid crystal device 3 of the present embodiment includes the microlens ML1 as the first microlens in which the shape of the first planar portion MLa1 matches the shape of the pixel aperture O1, and the microlens ML2 as the second microlens having substantially the same configuration as that of the first embodiment. According to this configuration, a desired illuminance distribution is formed on the pixel aperture O1 with the combination of the microlenses ML1, ML2. Therefore, the light passing through the second planar portion MLa2 from the first planar portion MLa1 can be emitted in a shape gradually matching the pixel aperture O1. Therefore, the degree of freedom in optical design is improved compared to when designing an optical system only with one microlens.

In addition, the modified example of the first embodiment may be applied to the microlens ML1 and the microlens ML2 of the present embodiment.

### Fourth Embodiment

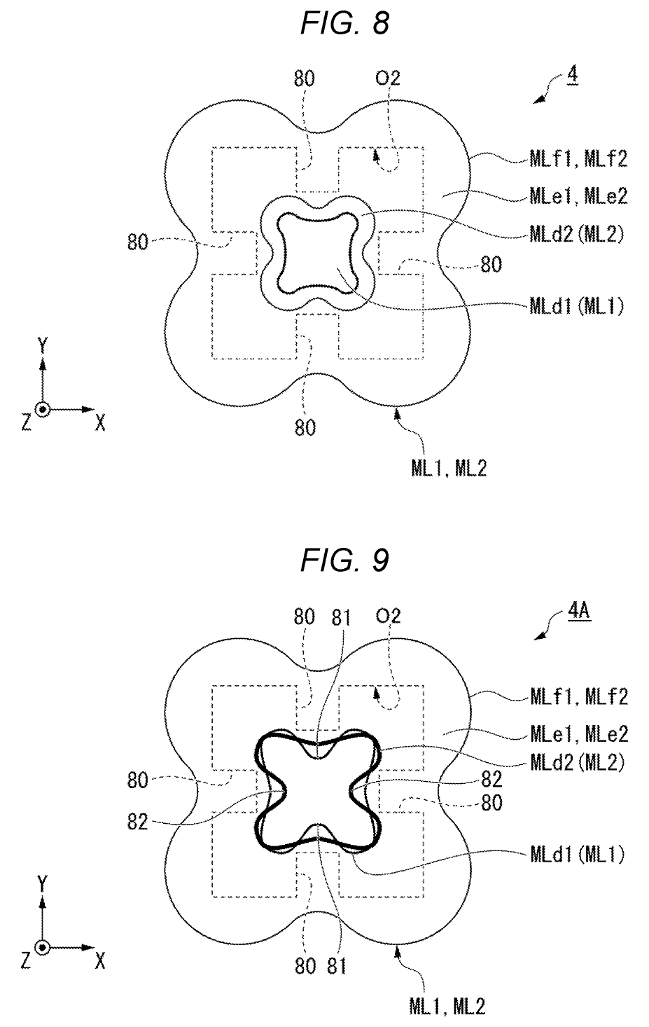

A fourth embodiment of the present disclosure will be described below with reference to FIG. 8. The present embodiment is substantially the same in basic configuration of the liquid crystal device 4 as the second embodiment, and is different in configuration of the first lens from the second embodiment. In FIG. 8, components common to those in the drawings used in the second embodiment are denoted by the same reference symbols to omit the description thereof.

FIG. 8 is a plan view illustrating the pixel aperture O2 and an essential part of the microlens ML1 and the microlens ML2 disposed at the pixel aperture O2 in the fourth embodiment.

As illustrated in FIG. 8, the lens shape of the microlens ML1 is the same as that of the microlens ML2 as a whole, and is a shape in which vertexes of the square are rounded and each of the sides is recessed toward the center.

The microlens ML1 includes a first planar portion MLd1 disposed in a central portion, a first curved portion MLe1 disposed around the first planar portion MLd1, and a first rim portion MLf1 in the plan view. The first planar portion MLd1 and the first curved portion MLe1 are formed continuously. The first planar portion MLd1 is formed such that four sides are recessed toward the lens center and four corners are each formed to have a circular shape toward the outside in the plan view. The four sides of the first planar portion MLd1 are formed symmetrically in the vertical and horizontal directions. The four corners of the first planar portion MLd1 are formed similarly to each other. The first planar portion MLd1 is a convex portion of the microlens ML1.

An amount of recess in the first planar portion MLd1 is different from an amount of recess in the second planar portion MLd2. In the present embodiment, the amount of recess in the first planar portion MLd1 is smaller than the amount of recess in the second planar portion MLd2. More specifically, the amount of recess of each of the four sides in the first planar portion MLd1 is smaller than the amount of recess of each of the four sides of the second planar portion MLd2.

Therefore, the light incident on the first planar portion MLa1 of the microlens ML1 is emitted in accordance with the shape of the first planar portion MLa1, and the light incident on the second planar portion MLa2 of the microlens ML2 is emitted in accordance with the shape of the second planar portion MLa2. Therefore, the light passing through the second planar portion MLa2 from the first planar portion MLa1 can be emitted in a shape gradually matching the pixel aperture O2.

Note that the first planar portion MLd1 and the second planar portion MLd2 may be the same in amount of recess. Further, the first planar portion MLd1 and the second planar portion MLd2 may be substantially similar to each other, and the second planar portion MLd2 may be larger in plane area than the first planar portion MLd1.

In addition, in the first planar portion MLd1 and the second planar portion MLd2, it is sufficient that the outer edge at a position corresponding to at least a part of the opening recess 80 is recessed toward the lens center. The first planar portion MLd1 and the second planar portion MLd2 are only required to be able to emit light in a shape matching the pixel aperture O2.

The first rim portion MLf1 forms the outer shape of the microlens ML1. The first rim portion MLf1 is substantially similar in shape to the second rim portion MLf2 in the plan view.

The first planar portion MLd1 is a surface which is substantially flat and is substantially parallel to the first surface 10a of the microlens array unit 10. The first planar portion MLd1 has a shape corresponding to the shape of the pixel aperture O2. More specifically, the first planar portion MLd1 is recessed in a rounded shape at a position corresponding to the opening recess 80 of the pixel aperture O2 in the plan view.

The first planar portion MLd1 is smaller in area than the pixel aperture O2 in the plan view. The first planar portion MLd1 is located inside the pixel aperture O2 in the plan view. Therefore, incident light L1 can surely be incident on the pixel aperture O2. Therefore, it is possible to reduce the light with which the periphery of the pixel aperture O2 is irradiated. Therefore, the first light blocking layer 22 and the second light blocking layer 26 constituting the edge portion of the pixel aperture O2 can be prevented from being irradiated with the light. Therefore, similarly to the first embodiment, it is possible to provide the liquid crystal device 4 and the electronic apparatus having the advantage of increasing the light use efficiency by increasing the amount of light emitted from the element substrate 20 side.

As described above, the liquid crystal device 4 of the present embodiment includes the microlens ML1 as the first microlens in which the shape of the first planar portion MLd1 matches the shape of the pixel aperture O2, and the microlens ML2 as the second microlens having substantially the same configuration as that of the second embodiment. According to this configuration, a desired illuminance distribution is formed on the pixel aperture O2 with the combination of the microlenses ML1, ML2. Therefore, the light passing through the second planar portion MLa2 from the first planar portion MLa1 can be emitted in a shape gradually matching the pixel aperture O2. Therefore, the degree of freedom in optical design is improved compared to when designing an optical system only with one microlens.

### Modified Example

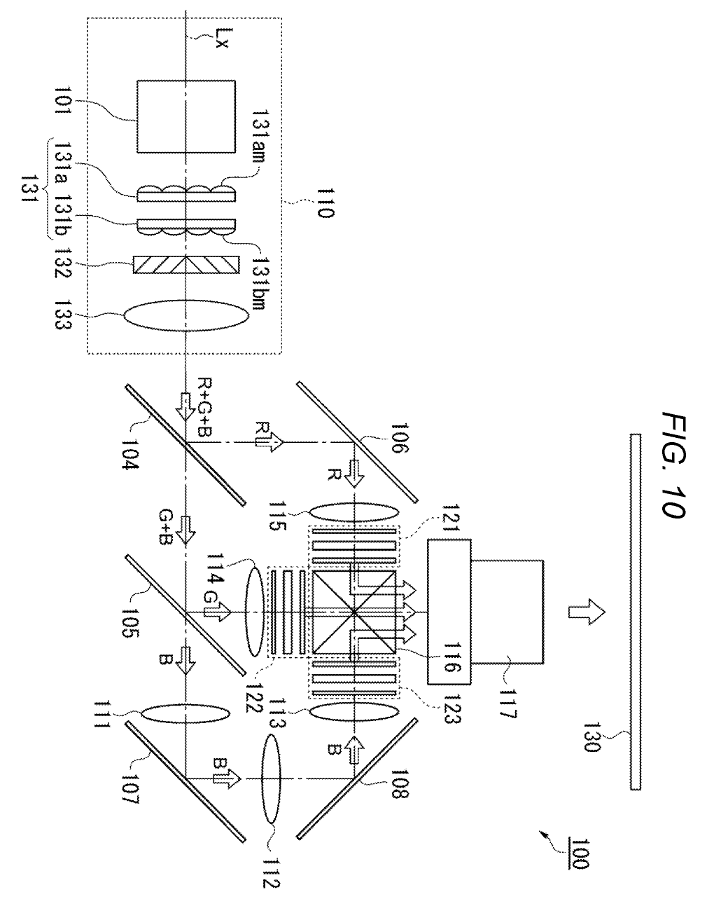

FIG. 9 shows a liquid crystal device 4A according to a modified example of the present embodiment. FIG. 9 is a plan view illustrating an essential part of a lens and a pixel aperture according to the modified example of the fourth embodiment. In the fourth embodiment, there is described when the amount of recess of each of the four sides of the first planar portion MLd1 is different from the amount of recess of each of the four sides of the second planar portion MLd2. However, as shown in FIG. 9, all of the four sides of the first planar portion MLd1 and the second planar portion MLd2 are not required to be recessed.

More specifically, the first planar portion MLd1 has first recesses 81 corresponding to the opening recesses 80 in the Y direction in the plan view. The second planar portion MLd2 has second recesses 82 corresponding to the opening recesses 80 in the X direction in the plan view.

The first recesses 81 correspond to some of the opening recesses 80. The second recesses 82 correspond to the rest of the opening recesses 80.

Note that the first recesses 81 may correspond to the opening recesses 80 in the X direction in the plan view. Similarly, the second recesses 82 may correspond to the opening recesses 80 in the Y direction in the plan view.

Accordingly, by the microlens array MLA, the light incident on the first planar portion MLa1 of the microlens ML1 is emitted in accordance with the shape of the first planar portion MLa1, and the light incident on the second planar portion MLa2 of the microlens ML2 is emitted in accordance with the shape of the second planar portion MLa2. That is, the light passing through the second planar portion MLa2 from the first planar portion MLa1 can be emitted in a shape gradually matching the pixel aperture O2.

In addition, by providing the first planar portion MLd1 with the first recesses 81 corresponding to the opening recesses 80 in the Y direction and providing the second planar portion MLd2 with the second recesses 82 corresponding to the opening recesses 80 in the X direction, the microlenses ML1, ML2 can be easily manufactured compared to when the recesses corresponding to the four sides, that is, the opening recesses 80 are provided to each of the first planar portion MLd1 and the second planar portion MLd2.

### Fifth Embodiment

Then, an electronic apparatus according to a fifth embodiment of the present disclosure will be described with reference to FIG. 10. FIG. 10 is a schematic diagram illustrating a configuration of an electronic apparatus. The electronic apparatus according to the present embodiment is a projector including the liquid crystal device according to any one of the first, second, third, and fourth embodiments.

As shown in FIG. 10, a projector (projection-type display apparatus) 100 according to the present embodiment includes an illumination device 110, two dichroic mirrors 104, 105, three reflecting mirrors 106, 107, and 108, five relay lenses 111, 112, 113, 114, and 115, three liquid crystal light valves 121, 122, and 123, a cross dichroic prism 116, and a projection lens 117.

The illumination device 110 includes a light source 101 formed of a white light source such as an ultra-high pressure mercury lamp or a halogen lamp, a lens integrator 131, a polarization conversion element 132, and a superimposing lens 133.

The lens integrator 131 includes a first multi-lens 131a and a second multi-lens 131b. The first multi-lens 131aincludes a plurality of first small lenses 131am for dividing the illumination light into a plurality of partial light beams.

The surfaces of the first small lens 131am, which is the lens surface of the first multi-lens 131a, and the image formation region of each of the liquid crystal light valves 121, 122, and 123 are conjugate to each other. Therefore, the shape of each of the first small lenses 131am is substantially similar to the shape of the image formation region of each of the liquid crystal light valves 121, 122, and 123. Accordingly, each of the partial light beams emitted from the first multi-lens 131a is efficiently incident on the image formation region of each of the liquid crystal light valves 121, 122, and 123.

The second multi-lens 131b includes a plurality of second small lenses 131bm corresponding to the plurality of first small lenses 131am of the first multi-lens 131a. The second multi-lens 131b forms an image of each of the first small lenses 131am of the first multi-lens 131a in the vicinity of each of the image formation regions of the liquid crystal light valves 121, 122, and 123 together with the superimposing lens 133.

The illumination light transmitted through the lens integrator 131 enters the polarization conversion element 132. The polarization conversion element 132 is formed of polarization separation films and half-wave plates arranged in an array. The polarization conversion element 132 converts the illumination light into a predetermined polarization component.

The dichroic mirror 104 reflects red light R and transmits green light G and blue light B out of the polarized light beams emitted from the illumination device 110. The other dichroic mirror 105 reflects the green light G transmitted through the dichroic mirror 104 and transmits the blue light B.

The red light R reflected by the dichroic mirror 104 is incident on the liquid crystal light valve 121 via the relay lens 115 after being reflected by the reflecting mirror 106. The green light G reflected by the dichroic mirror 105 is incident on the liquid crystal light valve 122 via the relay lens 114. The blue light B transmitted through the dichroic mirror 105 is incident on the liquid crystal light valve 123 via a light guide system configured with the three relay lenses 111, 112, and 113 and the two reflecting mirrors 107, 108.

The liquid crystal light valves 121, 122, and 123 of the transmissive type as light modulation elements are respectively arranged to face the planes of incidence for the respective colored light of the cross dichroic prism 116. The colored light incident on the liquid crystal light valves 121, 122, and 123 is modulated based on image information and is emitted toward the cross dichroic prism 116.

The cross dichroic prism 116 is configured with four rectangular prisms bonded to each other, and a dielectric multilayer film that reflects the red light and a dielectric multilayer film that reflects the blue light are formed in a cross shape on the inner surface thereof. The three colored light beams are combined by the dielectric multilayer films into light representing a color image. The light thus combined is projected on a screen 130 by the projection lens 117 which is the projection optical system and the image is displayed in an enlarged manner.

For example, the liquid crystal device 1 of the first embodiment is applied to the liquid crystal light valves 121, 122, and 123. The liquid crystal light valves 121, 122, and 123 are each disposed between a pair of polarization elements with gaps therebetween, wherein the polarization elements are disposed in a crossed Nicol arrangement at the incidence side and the exit side of the colored light.

As described above, the projector 100 according to the present embodiment includes the liquid crystal device 1 described above as a liquid crystal light valve.

According to the configuration of the projector 100 related to the present embodiment, since the liquid crystal devices 1 high in light use efficiency are provided as the liquid crystal light valves 121, 122, and 123, it is possible to project an image which is bright and high in quality.

Some preferable embodiments of the present disclosure have been described hereinabove in detail. However, the present disclosure is not limited to such specific embodiments, and various modifications and changes can be made thereto within the scope of the key points of the present disclosure set forth in the appended claims.

For example, the second planar portion MLa, the first planar portion MLa1, and the second planar portion MLa2 may be chamfered so as to cut off the four corners of the rectangular shape.

Further, in the fifth embodiment, the projector is exemplified as the electronic apparatus including the liquid crystal device 1, but this is not a limitation. Examples of the electronic apparatus including the liquid crystal device 1 according to the present disclosure include a projection-type head-up display, a direct-view-type head-mounted display, a personal computer, a digital camera, and a liquid crystal television.

### SUMMARY OF PRESENT DISCLOSURE

The present disclosure will be summarized below as appendices.

### Appendix 1

A liquid crystal device including:

a first substrate having a light transmissive property and including a plurality of pixel electrodes; a second substrate disposed so as to face the first substrate and including a lens layer; and a liquid crystal layer disposed between the first substrate and the second substrate, wherein the first substrate includes a plurality of pixel apertures which is disposed so as to correspond respectively to the plurality of pixel electrodes, and on which light from the lens layer is incident, each of the plurality of pixel apertures has a rectangular shape having a longitudinal direction and a transverse direction in plan view, the second substrate has a first surface on which the light is incident and a second surface from which the light is emitted, the lens layer includes a plurality of first lenses and a plurality of second lenses disposed so as to correspond respectively to the plurality of pixel electrodes, the plurality of first lenses is disposed at the first surface side of the second substrate, the plurality of second lenses is disposed at the second surface side with respect to the plurality of first lenses, the plurality of first lenses and the plurality of second lenses are arranged such that convex surfaces of the plurality of first lenses and convex surfaces of the plurality of second lenses face to respective sides opposite to each other, at least a part of the convex surface of each of the plurality of first lenses is formed of a curved surface, the convex surface of each of the plurality of second lenses includes a second planar portion disposed at a center and a second curved portion disposed so as to surround the second planar portion in plan view, the second planar portion has a rectangular shape having a longitudinal direction and a transverse direction in plan view, the longitudinal direction of the second planar portion is the same direction as the longitudinal direction of the pixel aperture, and the transverse direction of the second planar portion is the same direction as the transverse direction of the pixel aperture.

According to the liquid crystal device having this configuration, the light incident on the second substrate is condensed by each of the plurality of first lenses and is incident on each of the plurality of second lenses. Since each of the plurality of second lenses has a shape in which the shape of the second planar portion matches the shape of the pixel aperture, although a part of the light low in illuminance irradiates the outside of the pixel aperture, the inside of the pixel aperture can be irradiated with the light higher in illuminance. Therefore, compared to when the shape of the second planar portion is different from the shape of the pixel aperture, the light with which the surrounding area of the long sides corresponding to the longitudinal direction of the pixel aperture is irradiated can be decreased. Therefore, it is possible to prevent the edge portion of the pixel aperture from being irradiated with the light. Therefore, since it is possible to make a larger amount of light be incident on the pixel aperture from the microlens, the light use efficiency can be increased.

Appendix 2

A liquid crystal device including:

a first substrate having a light transmissive property and including a plurality of pixel electrodes; a second substrate disposed so as to face the first substrate and including a lens layer; and a liquid crystal layer disposed between the first substrate and the second substrate, wherein the first substrate includes a plurality of pixel apertures which is disposed so as to correspond respectively to the plurality of pixel electrodes, and on which light from the lens layer is incident, each of the plurality of pixel apertures has a plurality of recessed portions recessed toward a center in plan view, the second substrate has a first surface on which the light is incident and a second surface from which the light is emitted, the lens layer includes a plurality of first lenses and a plurality of second lenses disposed so as to correspond respectively to the plurality of pixel electrodes, the plurality of first lenses is disposed at the first surface side of the second substrate, the plurality of second lenses is disposed at the second surface side with respect to the plurality of first lenses, the plurality of first lenses and the plurality of second lenses are arranged such that convex surfaces of the plurality of first lenses and convex surfaces of the plurality of second lenses face to respective sides opposite to each other, at least a part of the convex surface of each of the plurality of first lenses is formed of a curved surface, the convex surface of each of the plurality of second lenses includes a second planar portion disposed at a center and a second curved portion disposed so as to surround the second planar portion in plan view, and in the second planar portion, an outer edge at positions corresponding to the plurality of recessed portions is recessed toward a lens center in plan view.

According to the liquid crystal device having this configuration, the light incident on the second substrate is condensed by the plurality of first lenses and is incident on the plurality of second lenses. The second planar portion of each of the plurality of second lenses has a shape in which an outer edge at a position corresponding to the recessed portion of the pixel aperture is recessed toward the lens center in plan view. That is, the shape of the second planar portion is a shape according to the shape of the pixel aperture. Therefore, although a part of the light low in illuminance irradiates the outside of the pixel aperture, the inside of the pixel aperture can be irradiated with the light higher in illuminance. In addition, compared to when the shape of the second planar portion is different from the shape of the pixel aperture, it is possible to reduce the light with which the periphery of the pixel aperture is irradiated. Therefore, it is possible to prevent the edge portion of the pixel aperture from being irradiated with the light. Therefore, since it is possible to make a larger amount of light be incident on the pixel aperture from the microlens, the light use efficiency can be increased.

Appendix 3

The liquid crystal device according to Appendix 1, wherein the convex surface of each of the plurality of first lenses includes a first planar portion disposed at a center and a first curved portion disposed so as to surround the first planar portion in plan view, the first planar portion has a rectangular shape having a longitudinal direction and a transverse direction in plan view, the longitudinal direction of the first planar portion is the same direction as the longitudinal direction of the pixel aperture, and the transverse direction of the first planar portion is the same direction as the transverse direction of the pixel aperture.

According to this configuration, the light incident on the second substrate is condensed by the curved portion of each of the plurality of first lenses and the curved portion of each of the plurality of second lenses. Since the first planar portion and the second planar portion have shapes according to the shape of the pixel aperture, although a part of the light low in illuminance irradiates the outside of the pixel aperture, the inside of the pixel aperture can be irradiated with the light higher in illuminance. Therefore, compared to when the shapes of the first planar portion and the second planar portion are different from the shape of the pixel aperture, the light with which the surrounding area of the long sides corresponding to the longitudinal direction of the pixel aperture is irradiated can be decreased. Therefore, it is possible to prevent the edge portion of the pixel aperture from being irradiated with the light. Therefore, since it is possible to make a larger amount of light be incident on the pixel aperture from the microlens, the light use efficiency can be increased. In addition, a desired illuminance distribution is formed on the pixel aperture by a combination of the plurality of first lenses in which the shape of the first planar portion matches the shape of the pixel aperture and the plurality of second lenses in which the shape of the second planar portion matches the shape of the pixel aperture. Therefore, the light passing through the second planar portion from the first planar portion can be emitted in a shape gradually matching the pixel aperture. Therefore, the degree of freedom in optical design is improved compared to when designing an optical system only with one lens.

Appendix 4

The liquid crystal device according to Appendix 2, wherein the convex surface of each of the plurality of first lenses includes a first planar portion disposed at a center and a first curved portion disposed so as to surround the first planar portion in plan view, an outer edge of the first planar portion at positions corresponding to at least some of the plurality of recessed portions is recessed toward a lens center in plan view, and an outer edge of the second planar portion at positions corresponding to at least some of the plurality of recessed portions is recessed toward the lens center in plan view.

According to this configuration, the light incident on the second substrate is condensed by the curved portion of each of the plurality of first lenses and the curved portion of each of the plurality of second lenses. The first planar portion and the second planar portion each have a shape in which an outer edge at the positions corresponding to the recessed portions of the pixel aperture is recessed toward the lens center in plan view. That is, the shapes of the first planar portion and the second planar portion match the shape of the pixel aperture. Therefore, although a part of the light low in illuminance irradiates the outside of the pixel aperture, the inside of the pixel aperture can be irradiated with the light higher in illuminance. In addition, compared to when the shapes of the first planar portion and the second planar portion are different from the shape of the pixel aperture, it is possible to reduce the light with which the periphery of the pixel aperture is irradiated. Therefore, it is possible to prevent the edge portion of the pixel aperture from being irradiated with the light. Therefore, since it is possible to make a larger amount of light be incident on the pixel aperture from the microlens, the light use efficiency can be increased. In addition, a desired illuminance distribution is formed on the pixel aperture by a combination of the plurality of first lenses in which the shape of the first planar portion matches the shape of the pixel aperture and the plurality of second lenses in which the shape of the second planar portion matches the shape of the pixel aperture. Therefore, the light passing through the second planar portion from the first planar portion can be emitted in a shape gradually matching the pixel aperture. Therefore, the degree of freedom in optical design is improved compared to when designing an optical system only with one lens.

Appendix 5

The liquid crystal device according to Appendix 3, wherein a plane area of the second planar portion is larger than a plane area of the first planar portion.

According to this configuration, the light emitted so as to spread to the outside of each of the plurality of first lenses due to the diffraction of the light can be made incident on the second planar portion. Accordingly, it is possible to prevent the illuminance in the pixel aperture from decreasing.

Appendix 6

The liquid crystal device according to Appendix 4, wherein the outer edge of the first planar portion at positions corresponding to the plurality of recessed portions is recessed toward the lens center in plan view, the outer edge of the second planar portion at positions corresponding to the plurality of recessed portions is recessed toward the lens center in plan view, and an amount of the recess in the first planar portion and an amount of the recess in the second planar portion are different from each other.

According to this configuration, the light incident on the first planar portion of each of the plurality of first lenses is emitted in accordance with the shape of the first planar portion, and the light incident on the second planar portion of each of the plurality of second lenses is emitted in accordance with the shape of the second planar portion. Therefore, the light passing through the second planar portion from the first planar portion can be emitted in a shape gradually matching the pixel aperture.

Appendix 7

The liquid crystal device according to Appendix 4, wherein the first planar portion includes first recesses which are the outer edge at positions corresponding to some of the plurality of recessed portions recessed toward the lens center in plan view, the second planar portion includes second recesses which are the outer edge at positions corresponding to the rest of the plurality of recessed portions recessed toward the lens center in plan view.

According to this configuration, the light incident on the first planar portion of each of the plurality of first lenses is emitted in accordance with the shape of the first planar portion, and the light incident on the second planar portion of each of the plurality of second lenses is emitted in accordance with the shape of the second planar portion. Therefore, the light passing through the second planar portion from the first planar portion can be emitted in a shape gradually matching the pixel aperture. In addition, the plurality of first lenses and the plurality of second lenses are easily manufactured compared to when forming the recesses corresponding respectively to the plurality of recessed portions in the first planar portion and the second planar portion.

Appendix 8

The liquid crystal device according to one of Appendices 1 and 2, wherein the second planar portion is located inside the pixel aperture in plan view.

According to this configuration, incident light can be made surely incident on the pixel aperture.

Appendix 9

The liquid crystal device according to one of Appendices 3 and 4, wherein the first planar portion and the second planar portion are located inside the pixel aperture in plan view.

According to this configuration, incident light can be made surely incident on the pixel aperture.

Appendix 10

An electronic apparatus including the liquid crystal device according to any one of Appendices 1 to 9.

According to the electronic apparatus having this configuration, since the liquid crystal device improved in light use efficiency is provided, it is possible to provide an electronic apparatus which is bright and high in quality.

What is claimed is:

1. A liquid crystal device comprising:
a first substrate having a light transmissive property and including a plurality of pixel electrodes;
a second substrate disposed so as to face the first substrate and including a lens layer; and
a liquid crystal layer disposed between the first substrate and the second substrate, wherein
the first substrate includes a plurality of pixel apertures which is disposed so as to correspond respectively to the plurality of pixel electrodes, and on which light from the lens layer is incident,
each of the plurality of pixel apertures has a rectangular shape having a longitudinal direction and a transverse direction in plan view,
the second substrate has a first surface on which the light is incident and a second surface from which the light is emitted,
the lens layer includes a plurality of first lenses and a plurality of second lenses disposed so as to correspond respectively to the plurality of pixel electrodes,
the plurality of first lenses is disposed at the first surface side of the second substrate,
the plurality of second lenses is disposed at the second surface side with respect to the plurality of first lenses,
the plurality of first lenses and the plurality of second lenses are arranged such that convex surfaces of the plurality of first lenses and convex surfaces of the plurality of second lenses face to respective sides opposite to each other,
at least a part of the convex surface of each of the plurality of first lenses is formed of a curved surface,
the convex surface of each of the plurality of second lenses includes a second planar portion disposed at a center and a second curved portion disposed so as to surround the second planar portion in plan view,
the second planar portion has a rectangular shape having a longitudinal direction and a transverse direction in plan view,
the longitudinal direction of the second planar portion is the same direction as the longitudinal direction of the pixel aperture, and
the transverse direction of the second planar portion is the same direction as the transverse direction of the pixel aperture.

2. The liquid crystal device according to claim 1, wherein
the convex surface of each of the plurality of first lenses includes a first planar portion disposed at a center and a first curved portion disposed so as to surround the first planar portion in plan view,
the first planar portion has a rectangular shape having a longitudinal direction and a transverse direction in plan view,
the longitudinal direction of the first planar portion is the same direction as the longitudinal direction of the pixel aperture, and
the transverse direction of the first planar portion is the same direction as the transverse direction of the pixel aperture.

3. The liquid crystal device according to claim 2, wherein
a plane area of the second planar portion is larger than a plane area of the first planar portion.

4. The liquid crystal device according to claim 1, wherein
the second planar portion is located inside the pixel aperture in plan view.

5. The liquid crystal device according to claim 2, wherein
the first planar portion and the second planar portion are located inside the pixel aperture in plan view.

6. An electronic apparatus comprising
the liquid crystal device according to claim 1.

7. A liquid crystal device comprising:
a first substrate having a light transmissive property and including a plurality of pixel electrodes;
a second substrate disposed so as to face the first substrate and including a lens layer; and
a liquid crystal layer disposed between the first substrate and the second substrate, wherein
the first substrate includes a plurality of pixel apertures which is disposed so as to correspond respectively to the plurality of pixel electrodes, and on which light from the lens layer is incident,
each of the plurality of pixel apertures has a plurality of recessed portions recessed toward a center in plan view,
the second substrate has a first surface on which the light is incident and a second surface from which the light is emitted,
the lens layer includes a plurality of first lenses and a plurality of second lenses disposed so as to correspond respectively to the plurality of pixel electrodes,
the plurality of first lenses is disposed at the first surface side of the second substrate,
the plurality of second lenses is disposed at the second surface side with respect to the plurality of first lenses,
the plurality of first lenses and the plurality of second lenses are arranged such that convex surfaces of the plurality of first lenses and convex surfaces of the plurality of second lenses face to respective sides opposite to each other,
at least a part of the convex surface of each of the plurality of first lenses is formed of a curved surface,
the convex surface of each of the plurality of second lenses includes a second planar portion disposed at a center and a second curved portion disposed so as to surround the second planar portion in plan view, and
in the second planar portion, an outer edge at positions corresponding to the plurality of recessed portions is recessed toward a lens center in plan view.

8. The liquid crystal device according to claim 7, wherein
the convex surface of each of the plurality of first lenses includes a first planar portion disposed at a center and a first curved portion disposed so as to surround the first planar portion in plan view,
an outer edge of the first planar portion at positions corresponding to at least some of the plurality of recessed portions is recessed toward a lens center in plan view, and
an outer edge of the second planar portion at positions corresponding to at least some of the plurality of recessed portions is recessed toward the lens center in plan view.

9. The liquid crystal device according to claim 8, wherein
the outer edge of the first planar portion at positions corresponding to the plurality of recessed portions is recessed toward the lens center in plan view,
the outer edge of the second planar portion at positions corresponding to the plurality of recessed portions is recessed toward the lens center in plan view, and
an amount of the recess in the first planar portion and an amount of the recess in the second planar portion are different from each other.

10. The liquid crystal device according to claim 8, wherein
the first planar portion includes first recesses which are the outer edge at positions corresponding to some of the plurality of recessed portions recessed toward the lens center in plan view,
the second planar portion includes second recesses which are the outer edge at positions corresponding to the rest of the plurality of recessed portions recessed toward the lens center in plan view.
